(19) United States
(12) Patent Application Publication
(10) Pub. No.: US 2026/0051264 A1
(43) Pub. Date: Feb. 19, 2026

(54) SYSTEM

(71) Applicant: SoftBank Group Corp., Tokyo (JP)

(72) Inventor: Teruyuki KAMEDA, Tokyo (JP)

(21) Appl. No.: 19/294,814

(22) Filed: Aug. 8, 2025

(30) Foreign Application Priority Data
Aug. 16, 2024 (JP) 2024-136018

(51) Int. Cl. G09B 21/00; G02B 27/01; G06F 3/16; G06T 7/70; G06V 10/74; G06V 10/82; G06V 30/14; G06V 40/16

(52) U.S. Cl. CPC G09B 21/006; G02B 27/0101; G02B 27/0172; G06F 3/167; G06T 7/70; G06V 10/761; G06V 10/82; G06V 30/14; G06V 40/174; G02B 2027/0138; G02B 2027/014; G02B 2027/0178; G06T 2207/20081; G06T 2207/20084; G06T 2207/30201; G06V 2201/07

(57) ABSTRACT

The system according to the embodiment comprises a camera, an analysis unit, and a voice output unit. The camera is mounted on glasses. The analysis unit analyzes images acquired by the camera. The voice output unit outputs, as audio, information analyzed by the analysis unit.

### CROSS-REFERENCE TO RELATED APPLICATION

The present application claims priority to and incorporates by reference the entire contents of Japanese Patent Application No. 2024-136018 filed in Japan on Aug. 16, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, the means by which visually impaired individuals obtain visual information in daily life are limited, and there is room for improvement.

### SUMMARY OF THE INVENTION

The system according to the embodiment includes a camera, an analysis unit, and a voice output unit. The camera is mounted on glasses. The analysis unit analyzes images acquired by the camera. The voice output unit outputs, as audio, information analyzed by the analysis unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

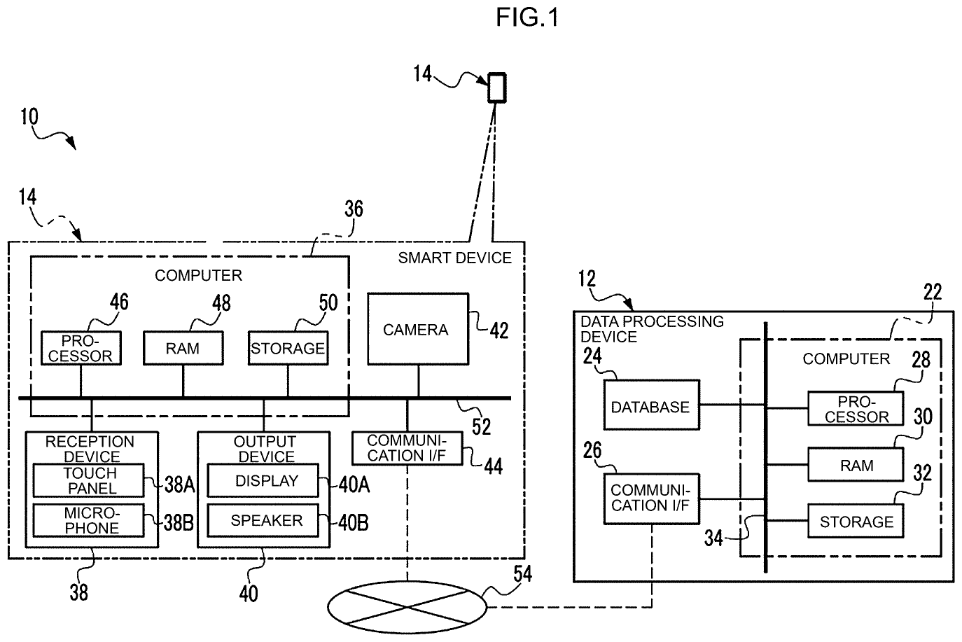

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

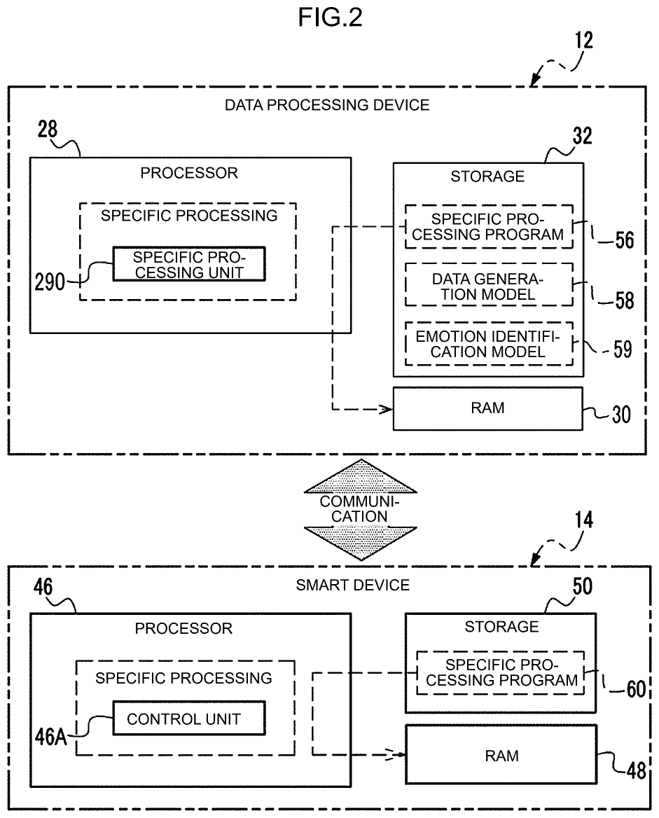

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The visual information support system according to the embodiment of the present invention is a multifunctional system that supports visual information by having a generative AI analyze images captured using two cameras mounted on glasses. As a result, the visual information support system can provide multifaceted support for the daily lives of visually impaired individuals.

The visual information support system according to the embodiment includes a camera, an analysis unit, and a voice output unit. The camera is mounted on glasses and acquires images. For example, the camera may have high resolution, a wide field of view, and a high frame rate. The analysis unit analyzes images acquired by the camera. For example, the analysis unit may use image processing algorithms to analyze the images and extract information with high accuracy. The voice output unit outputs, as audio, information analyzed by the analysis unit. For example, the voice output unit may use speech synthesis technology to generate high-quality audio. In this way, the visual information support system can provide a multifunctional system that supports the daily lives of visually impaired individuals.

The analysis unit can analyze character information from images acquired by the camera and read the character information aloud. For example, when the generative AI analyzes character information, it understands the context and adds appropriate intonation and emotion when reading aloud. For example, it adds a questioning tone to questions and a tone of gratitude to words of thanks. The analysis unit also analyzes the structure of the text and creates natural pauses at each paragraph to achieve natural reading. For example, it detects punctuation marks and line breaks and inserts appropriate pauses. Furthermore, the analysis unit performs sentiment analysis, reads the emotional nuances of the text, and reflects those emotions when reading aloud. For example, it uses a bright tone for expressions of joy and a calm tone for expressions of sadness. This allows visually impaired individuals to receive character information as audio when reading documents.

The analysis unit can recognize tactile paving blocks from images acquired by the camera and provide audio guidance regarding their position and orientation. For example, when the generative AI analyzes character information, it also analyzes the content of related images and diagrams and provides explanations via audio. For example, it conveys detailed explanations of graphs and diagrams. The analysis unit also uses image recognition technology to identify important elements in the image and explains them via audio. For example, it describes people or objects in a photograph. Furthermore, the analysis unit analyzes data in tables and reads out numerical and statistical information via audio. For example, it explains numbers in tables or data points in graphs. This enables the system to provide guidance for visually impaired individuals to move safely.

The analysis unit can analyze images of persons acquired by the camera and match them with persons registered in advance as training data. For example, the generative AI analyzes the user's emotional state in real time and adjusts the reading speed and tone based on the result. For example, if the user is relaxed, it reads aloud in a slow tone. The analysis unit also uses an emotion estimation function to emphasize and read important information quickly if the user is in a hurry. For example, it promptly conveys urgent notifications or important messages. Furthermore, the analysis unit adjusts the order of the content to be read aloud according to the user's emotional state. For example, if the user is excited, it reads out interesting information first. This allows visually impaired individuals to receive audio information about the results of person matching when finding acquaintances.

The analysis unit can analyze two images acquired by the camera and measure the distance to a target object. For example, the generative AI analyzes the movement and speed of the target object and provides dynamic distance information based on that data. For example, it measures the distance to moving vehicles or pedestrians in real time. The analysis unit also analyzes the speed of the target object and adjusts the distance information accordingly. For example, it issues a quick warning for fast-moving objects. Furthermore, the analysis unit analyzes the movement patterns of the target object and provides distance information according to the movement. For example, it predicts the movement of objects moving in a zigzag pattern and measures the distance. This allows visually impaired individuals to receive audio information about the distance to objects when avoiding obstacles.

The analysis unit can detect objects or situations other than the specified target object from images acquired by the camera. For example, when the generative AI detects foreign objects, it analyzes the type and risk level of the foreign object and provides detailed information. For example, it determines whether a fallen object is dangerous. The analysis unit also analyzes the type of foreign object and issues appropriate warnings to the user based on that information. For example, it warns the user when glass shards or sharp objects are detected. Furthermore, the analysis unit analyzes the risk level of the foreign object and adjusts the intensity of the warning based on the result. For example, it issues a strong warning for highly dangerous foreign objects. This allows visually impaired individuals to detect foreign objects while walking and receive that information via audio.

In addition to reading out character information, the analysis unit can also explain related images and diagrams via audio. For example, when the generative AI analyzes character information, it simultaneously analyzes the content of related images and diagrams and provides explanations via audio. For example, it conveys detailed explanations of graphs and diagrams. The analysis unit also uses image recognition technology to identify important elements in the image and explains them via audio. For example, it describes people or objects in a photograph. Furthermore, the analysis unit analyzes data in tables and reads out numerical and statistical information via audio. For example, it explains numbers in tables or data points in graphs. This allows visually impaired individuals to receive audio information about images and diagrams when reading documents.

When recognizing the position of tactile paving blocks, the analysis unit can simultaneously analyze information about surrounding obstacles and terrain to provide more detailed guidance. For example, when the generative AI recognizes the position of tactile paving blocks, it also analyzes information about surrounding obstacles and terrain and provides detailed guidance. For example, it provides audio guidance about stairs or steps ahead of the tactile paving blocks. The analysis unit also considers surrounding terrain information when analyzing the position of tactile paving blocks and proposes optimal routes. For example, it guides the user along routes that avoid slopes or uneven roads. Furthermore, the analysis unit analyzes the types and positions of surrounding obstacles in detail when recognizing the position of tactile paving blocks and conveys this information via audio. For example, it detects moving obstacles such as vehicles or bicycles and issues warnings. This allows visually impaired individuals to receive detailed guidance for safe movement.

In addition to audio guidance, the analysis unit can convey information to the user using vibration or haptic feedback. For example, the generative AI, in addition to audio guidance, uses vibration or haptic feedback to convey information to the user. For example, it notifies the user of the position of tactile paving blocks through vibration. The analysis unit also uses haptic feedback to inform the user of the position or type of obstacles. For example, it varies the strength or pattern of vibration to distinguish between types of obstacles. Furthermore, the analysis unit combines audio guidance and haptic feedback to provide detailed information to the user. For example, it guides direction via audio and notifies distance via vibration. This allows visually impaired individuals to receive information not only through audio but also through vibration and haptic feedback.

Based on the results of person matching, the analysis unit can convey past conversation history and relationships via audio. For example, the generative AI conveys past conversation history and relationships based on the matching results. For example, it provides information about previous conversations or mutual acquaintances. The analysis unit also analyzes the relationship between the user and the matched person based on the matching results and conveys this information via audio. For example, it explains relationships such as family or friends. Furthermore, the analysis unit analyzes past conversation history and conveys important interactions with the matched person via audio. For example, it reminds the user of previous promises or important topics. This allows visually impaired individuals to confirm past conversation history and relationships with acquaintances via audio.

The analysis unit can analyze the movement and speed of a target object and provide dynamic distance information. For example, the generative AI analyzes the movement and speed of the target object and provides dynamic distance information based on that data. For example, it measures the distance to moving vehicles or pedestrians in real time. The analysis unit also analyzes the speed of the target object and adjusts the distance information accordingly. For example, it issues a quick warning for fast-moving objects. Furthermore, the analysis unit analyzes the movement patterns of the target object and provides distance information according to the movement. For example, it predicts the movement of objects moving in a zigzag pattern and measures the distance. This allows visually impaired individuals to obtain real-time distance information to dynamic objects.

Based on the distance measurement results, the analysis unit can propose a safe travel route to the user. For example, the generative AI proposes a safe travel route to the user based on the distance measurement results. For example, it provides audio guidance for routes that avoid obstacles. The analysis unit also analyzes the distance measurement results and proposes the optimal travel route to the user in real time. For example, it guides the user along routes that avoid crowded areas. Furthermore, the analysis unit visually displays a safe travel route to the user based on the distance measurement results. For example, it displays the route in cooperation with a smartphone map application. This allows visually impaired individuals to be guided along safe travel routes via audio.

When detecting foreign objects, the analysis unit can analyze the type and risk level of the foreign object and provide detailed information. For example, the generative AI analyzes the type and risk level of the foreign object when detecting it and provides detailed information. For example, it determines whether a fallen object is dangerous. The analysis unit also analyzes the type of foreign object and issues appropriate warnings to the user based on that information. For example, it warns the user when glass shards or sharp objects are detected. Furthermore, the analysis unit analyzes the risk level of the foreign object and adjusts the intensity of the warning based on the result. For example, it issues a strong warning for highly dangerous foreign objects. This allows visually impaired individuals to know the type and risk level of foreign objects in detail.

Based on the foreign object detection results, the analysis unit can propose avoidance actions to the user. For example, the generative AI proposes avoidance actions to the user based on the foreign object detection results. For example, it provides audio guidance for routes to avoid foreign objects. The analysis unit also analyzes the position and type of foreign objects and proposes specific avoidance actions to the user. For example, it guides the user to turn right to avoid a foreign object. Furthermore, the analysis unit proposes avoidance actions to the user in real time based on the foreign object detection results. For example, if the foreign object is moving, it proposes avoidance actions according to its movement. This allows visually impaired individuals to take appropriate actions to avoid foreign objects.

The analysis unit can adapt the foreign object detection function to both indoor and outdoor environments, enabling detection of foreign objects in a wide range of situations. For example, the generative AI adapts the foreign object detection function to both indoor and outdoor environments, enabling detection of foreign objects in various situations. For example, it detects indoor furniture or outdoor obstacles. The analysis unit also adjusts the foreign object detection function according to the environment and detects foreign objects in different situations. For example, it optimizes foreign object detection in dark or bright places. Furthermore, the analysis unit analyzes indoor and outdoor environmental data and dynamically adjusts the foreign object detection function based on that information. For example, it improves the accuracy of foreign object detection according to weather or time of day. This allows visually impaired individuals to detect foreign objects in various indoor and outdoor environments.

Based on the foreign object detection results, the analysis unit can propose appropriate evacuation routes to the user. For example, the generative AI proposes appropriate evacuation routes to the user based on the foreign object detection results. For example, it provides audio guidance for safe routes to avoid foreign objects. The analysis unit also analyzes the position and type of foreign objects and proposes specific evacuation routes to the user. For example, it guides the user along evacuation routes suitable for emergencies such as fires or earthquakes. Furthermore, the analysis unit proposes evacuation routes to the user in real time based on the foreign object detection results. For example, if the foreign object is moving, it adjusts the evacuation route according to its movement. This allows visually impaired individuals to know appropriate evacuation routes to avoid foreign objects.

The system according to the embodiment is not limited to the above examples and can be variously modified, for example, as follows.

The analysis unit can analyze weather information from images acquired by the camera and provide appropriate advice to the user. For example, if it starts to rain, it provides audio guidance to carry an umbrella. The analysis unit can also propose appropriate clothing to the user based on weather information. For example, on cold days, it guides the user to wear warm clothes. Furthermore, the analysis unit can propose changes to the travel route based on weather information. For example, if roads become slippery due to heavy rain or snow, it guides the user along an alternative safe route. This makes it easier for visually impaired individuals to respond to changes in weather.

The analysis unit can analyze the user's health condition from images acquired by the camera and provide appropriate advice. For example, it detects signs of fatigue or stress from facial color or expression and provides audio guidance to take a break. The analysis unit can also analyze the user's walking pattern and, if any abnormality is detected, guide the user to see a doctor. For example, if the user's gait becomes unstable, it suggests visiting a medical institution early. Furthermore, the analysis unit can provide daily life advice based on the user's health condition. For example, it proposes appropriate diet or exercise. This makes it easier for visually impaired individuals to maintain their health.

The analysis unit can analyze surrounding sound information from images acquired by the camera and provide appropriate advice to the user. For example, it detects car engine sounds or horn sounds and prompts the user to be careful when crossing the road. The analysis unit can also propose appropriate actions to the user based on surrounding sound information. For example, it guides the user to use earplugs in noisy places. Furthermore, the analysis unit can propose safe travel routes to the user based on surrounding sound information. For example, it guides the user to choose a quiet road for travel. This allows visually impaired individuals to use surrounding sound information to move safely.

The analysis unit can analyze the user's posture from images acquired by the camera and provide appropriate advice. For example, if the user remains in the same posture for a long time, it provides audio guidance to stretch. The analysis unit can also propose appropriate sitting or standing postures based on the user's posture. For example, it guides the user to straighten their back. Furthermore, the analysis unit can provide daily life advice based on the user's posture. For example, it proposes correct working methods for maintaining good posture. This makes it easier for visually impaired individuals to maintain a healthy posture.

The analysis unit can analyze temperature information around the user from images acquired by the camera and provide appropriate advice. For example, if the room temperature is too high, it provides audio guidance to use the air conditioner. The analysis unit can also propose appropriate clothing to the user based on temperature information. For example, it guides the user to wear light clothing on hot days. Furthermore, the analysis unit can propose appropriate actions to the user based on temperature information. For example, if there is a high risk of heatstroke, it provides guidance to stay hydrated. This allows visually impaired individuals to use temperature information to stay comfortable.

The following is a brief explanation of the processing flow of Example 1 of the Embodiment.

Step 1: The camera is mounted on glasses and acquires images. For example, the camera may have high resolution, a wide field of view, and a high frame rate.

Step 2: The analysis unit analyzes images acquired by the camera. For example, the analysis unit may use image processing algorithms to analyze the images and extract information with high accuracy.

Step 3: The voice output unit outputs, as audio, information analyzed by the analysis unit. For example, the voice output unit may use speech synthesis technology to generate high-quality audio.

### Example 2 of Embodiment

The visual information support system according to the embodiment of the present invention is a multifunctional system that supports visual information by having a generative AI analyze images captured using two cameras mounted on glasses. As a result, the visual information support system can provide multifaceted support for the daily lives of visually impaired individuals.

The visual information support system according to the embodiment includes a camera, an analysis unit, and a voice output unit. The camera is mounted on glasses and acquires images. For example, the camera may have high resolution, a wide field of view, and a high frame rate. The analysis unit analyzes images acquired by the camera. For example, the analysis unit may use image processing algorithms to analyze the images and extract information with high accuracy. The voice output unit outputs, as audio, information analyzed by the analysis unit. For example, the voice output unit may use speech synthesis technology to generate high-quality audio. In this way, the visual information support system can provide a multifunctional system that supports the daily lives of visually impaired individuals.

The analysis unit can analyze character information from images acquired by the camera and read the character information aloud. For example, when the generative AI analyzes character information, it understands the context and adds appropriate intonation and emotion when reading aloud. For example, it adds a questioning tone to questions and a tone of gratitude to words of thanks. The analysis unit also analyzes the structure of the text and creates natural pauses at each paragraph to achieve natural reading. For example, it detects punctuation marks and line breaks and inserts appropriate pauses. Furthermore, the analysis unit performs sentiment analysis, reads the emotional nuances of the text, and reflects those emotions when reading aloud. For example, it uses a bright tone for expressions of joy and a calm tone for expressions of sadness. This allows visually impaired individuals to receive character information as audio when reading documents.

The analysis unit can recognize tactile paving blocks from images acquired by the camera and provide audio guidance regarding their position and orientation. For example, when the generative AI analyzes character information, it also analyzes the content of related images and diagrams and provides explanations via audio. For example, it conveys detailed explanations of graphs and diagrams. The analysis unit also uses image recognition technology to identify important elements in the image and explains them via audio. For example, it describes people or objects in a photograph. Furthermore, the analysis unit analyzes data in tables and reads out numerical and statistical information via audio. For example, it explains numbers in tables or data points in graphs. This enables the system to provide guidance for visually impaired individuals to move safely.

The analysis unit can analyze images of persons acquired by the camera and match them with persons registered in advance as training data. For example, the generative AI analyzes the user's emotional state in real time and adjusts the reading speed and tone based on the result. For example, if the user is relaxed, it reads aloud in a slow tone. The analysis unit also uses an emotion estimation function to emphasize and read important information quickly if the user is in a hurry. For example, it promptly conveys urgent notifications or important messages. Furthermore, the analysis unit adjusts the order of the content to be read aloud according to the user's emotional state. For example, if the user is excited, it reads out interesting information first. This allows visually impaired individuals to receive audio information about the results of person matching when finding acquaintances.

The analysis unit can analyze two images acquired by the camera and measure the distance to a target object. For example, the generative AI analyzes the movement and speed of the target object and provides dynamic distance information based on that data. For example, it measures the distance to moving vehicles or pedestrians in real time. The analysis unit also analyzes the speed of the target object and adjusts the distance information accordingly. For example, it issues a quick warning for fast-moving objects. Furthermore, the analysis unit analyzes the movement patterns of the target object and provides distance information according to the movement. For example, it predicts the movement of objects moving in a zigzag pattern and measures the distance. This allows visually impaired individuals to receive audio information about the distance to objects when avoiding obstacles.

The analysis unit can detect objects or situations other than the specified target object from images acquired by the camera. For example, when the generative AI detects foreign objects, it analyzes the type and risk level of the foreign object and provides detailed information. For example, it determines whether a fallen object is dangerous. The analysis unit also analyzes the type of foreign object and issues appropriate warnings to the user based on that information. For example, it warns the user when glass shards or sharp objects are detected. Furthermore, the analysis unit analyzes the risk level of the foreign object and adjusts the intensity of the warning based on the result. For example, it issues a strong warning for highly dangerous foreign objects. This allows visually impaired individuals to detect foreign objects while walking and receive that information via audio.

The analysis unit can understand context and add appropriate intonation and emotion when reading out character information. For example, when the generative AI analyzes character information, it understands the context and adds appropriate intonation and emotion when reading aloud. For example, it adds a questioning tone to questions and a tone of gratitude to words of thanks. The analysis unit also analyzes the structure of the text and creates natural pauses at each paragraph to achieve natural reading. For example, it detects punctuation marks and line breaks and inserts appropriate pauses. Furthermore, the analysis unit performs sentiment analysis, reads the emotional nuances of the text, and reflects those emotions when reading aloud. For example, it uses a bright tone for expressions of joy and a calm tone for expressions of sadness. This allows visually impaired individuals to receive character information in a more natural voice when reading documents.

In addition to reading out character information, the analysis unit can also explain related images and diagrams via audio. For example, when the generative AI analyzes character information, it simultaneously analyzes the content of related images and diagrams and provides explanations via audio. For example, it conveys detailed explanations of graphs and diagrams. The analysis unit also uses image recognition technology to identify important elements in the image and explains them via audio. For example, it describes people or objects in a photograph. Furthermore, the analysis unit analyzes data in tables and reads out numerical and statistical information via audio. For example, it explains numbers in tables or data points in graphs. This allows visually impaired individuals to receive audio information about images and diagrams when reading documents.

The analysis unit can use an emotion estimation function to adjust the reading speed and tone according to the user's emotional state. For example, the generative AI analyzes the user's emotional state in real time and adjusts the reading speed and tone based on the result. For example, if the user is relaxed, it reads aloud in a slow tone. The analysis unit also uses an emotion estimation function to emphasize and read important information quickly if the user is in a hurry. For example, it promptly conveys urgent notifications or important messages. Furthermore, the analysis unit adjusts the order of the content to be read aloud according to the user's emotional state. For example, if the user is excited, it reads out interesting information first. This allows character information to be conveyed in a more appropriate voice according to the user's emotional state.

When recognizing the position of tactile paving blocks, the analysis unit can simultaneously analyze information about surrounding obstacles and terrain to provide more detailed guidance. For example, when the generative AI recognizes the position of tactile paving blocks, it also analyzes information about surrounding obstacles and terrain and provides detailed guidance. For example, it provides audio guidance about stairs or steps ahead of the tactile paving blocks. The analysis unit also considers surrounding terrain information when analyzing the position of tactile paving blocks and proposes optimal routes. For example, it guides the user along routes that avoid slopes or uneven roads. Furthermore, the analysis unit analyzes the types and positions of surrounding obstacles in detail when recognizing the position of tactile paving blocks and conveys this information via audio. For example, it detects moving obstacles such as vehicles or bicycles and issues warnings. This allows visually impaired individuals to receive detailed guidance for safe movement.

In addition to audio guidance, the analysis unit can convey information to the user using vibration or haptic feedback. For example, the generative AI, in addition to audio guidance, uses vibration or haptic feedback to convey information to the user. For example, it notifies the user of the position of tactile paving blocks through vibration. The analysis unit also uses haptic feedback to inform the user of the position or type of obstacles. For example, it varies the strength or pattern of vibration to distinguish between types of obstacles. Furthermore, the analysis unit combines audio guidance and haptic feedback to provide detailed information to the user. For example, it guides direction via audio and notifies distance via vibration. This allows visually impaired individuals to receive information not only through audio but also through vibration and haptic feedback.

The analysis unit can use an emotion estimation function to adjust the frequency and level of detail of guidance according to the user's stress level. For example, the generative AI analyzes the user's stress level and adjusts the frequency and level of detail of guidance based on the result. For example, if the user is feeling stressed, it provides detailed guidance. The analysis unit also uses an emotion estimation function to adjust the content of guidance according to the user's stress level. For example, if the user is relaxed, it provides concise guidance. Furthermore, the analysis unit monitors the user's stress level in real time and dynamically adjusts the frequency and level of detail of guidance according to changes. For example, if stress increases, it provides guidance more frequently. This allows appropriate guidance to be provided according to the user's stress level.

Based on the results of person matching, the analysis unit can convey past conversation history and relationships via audio. For example, the generative AI conveys past conversation history and relationships based on the matching results. For example, it provides information about previous conversations or mutual acquaintances. The analysis unit also analyzes the relationship between the user and the matched person based on the matching results and conveys this information via audio. For example, it explains relationships such as family or friends. Furthermore, the analysis unit analyzes past conversation history and conveys important interactions with the matched person via audio. For example, it reminds the user of previous promises or important topics. This allows visually impaired individuals to confirm past conversation history and relationships with acquaintances via audio.

The analysis unit can use an emotion estimation function to analyze the user's feelings toward a specific person and provide information according to those feelings. For example, the generative AI analyzes the user's emotional state and provides information according to the user's feelings toward a specific person. For example, it conveys good news about a person for whom the user has positive feelings. The analysis unit also uses an emotion estimation function to analyze the user's feelings toward a specific person and adjust the priority of information based on those feelings. For example, it conveys important information first. Furthermore, the analysis unit monitors the user's emotional state in real time and provides information according to changes. For example, if the user is relaxed, it provides detailed information. This allows information about a specific person to be appropriately provided according to the user's feelings.

The analysis unit can analyze the movement and speed of a target object and provide dynamic distance information. For example, the generative AI analyzes the movement and speed of the target object and provides dynamic distance information based on that data. For example, it measures the distance to moving vehicles or pedestrians in real time. The analysis unit also analyzes the speed of the target object and adjusts the distance information accordingly. For example, it issues a quick warning for fast-moving objects. Furthermore, the analysis unit analyzes the movement patterns of the target object and provides distance information according to the movement. For example, it predicts the movement of objects moving in a zigzag pattern and measures the distance. This allows visually impaired individuals to obtain real-time distance information to dynamic objects.

Based on the distance measurement results, the analysis unit can propose a safe travel route to the user. For example, the generative AI proposes a safe travel route to the user based on the distance measurement results. For example, it provides audio guidance for routes that avoid obstacles. The analysis unit also analyzes the distance measurement results and proposes the optimal travel route to the user in real time. For example, it guides the user along routes that avoid crowded areas. Furthermore, the analysis unit visually displays a safe travel route to the user based on the distance measurement results. For example, it displays the route in cooperation with a smartphone map application. This allows visually impaired individuals to be guided along safe travel routes via audio.

The analysis unit can use an emotion estimation function to issue warnings for distances that cause the user to feel anxiety. For example, the generative AI analyzes the user's emotional state and issues warnings for distances that cause anxiety. For example, it provides an audio warning when the user approaches a distance that causes anxiety. The analysis unit also uses an emotion estimation function to monitor in real time the distance that causes the user to feel anxiety and adjust the intensity of the warning according to the distance. For example, the warning sound becomes louder as the distance decreases. Furthermore, the analysis unit issues visual warnings for distances that cause anxiety based on the user's emotional state. For example, it displays a warning message on the smartphone screen. This allows appropriate warnings to be issued for distances that cause the user to feel anxiety.

When detecting foreign objects, the analysis unit can analyze the type and risk level of the foreign object and provide detailed information. For example, the generative AI analyzes the type and risk level of the foreign object when detecting it and provides detailed information. For example, it determines whether a fallen object is dangerous. The analysis unit also analyzes the type of foreign object and issues appropriate warnings to the user based on that information. For example, it warns the user when glass shards or sharp objects are detected. Furthermore, the analysis unit analyzes the risk level of the foreign object and adjusts the intensity of the warning based on the result. For example, it issues a strong warning for highly dangerous foreign objects. This allows visually impaired individuals to know the type and risk level of foreign objects in detail.

Based on the foreign object detection results, the analysis unit can propose avoidance actions to the user. For example, the generative AI proposes avoidance actions to the user based on the foreign object detection results. For example, it provides audio guidance for routes to avoid foreign objects. The analysis unit also analyzes the position and type of foreign objects and proposes specific avoidance actions to the user. For example, it guides the user to turn right to avoid a foreign object. Furthermore, the analysis unit proposes avoidance actions to the user in real time based on the foreign object detection results. For example, if the foreign object is moving, it proposes avoidance actions according to its movement. This allows visually impaired individuals to take appropriate actions to avoid foreign objects.

The analysis unit can use an emotion estimation function to analyze the user's feelings toward foreign objects and issue warnings according to those feelings. For example, the generative AI analyzes the user's emotional state and issues warnings according to the user's feelings toward foreign objects. For example, if the user feels anxious, it issues a strong warning. The analysis unit also uses an emotion estimation function to analyze the user's feelings toward foreign objects and adjust the content of the warning based on those feelings. For example, if the user is relaxed, it issues a concise warning. Furthermore, the analysis unit monitors the user's emotional state in real time and dynamically adjusts the intensity and content of the warning according to changes. For example, if the user's emotions change, it immediately changes the content of the warning. This allows appropriate warnings to be issued for foreign objects according to the user's feelings.

The analysis unit can adapt the foreign object detection function to both indoor and outdoor environments, enabling detection of foreign objects in a wide range of situations. For example, the generative AI adapts the foreign object detection function to both indoor and outdoor environments, enabling detection of foreign objects in various situations. For example, it detects indoor furniture or outdoor obstacles. The analysis unit also adjusts the foreign object detection function according to the environment and detects foreign objects in different situations. For example, it optimizes foreign object detection in dark or bright places. Furthermore, the analysis unit analyzes indoor and outdoor environmental data and dynamically adjusts the foreign object detection function based on that information. For example, it improves the accuracy of foreign object detection according to weather or time of day. This allows visually impaired individuals to detect foreign objects in various indoor and outdoor environments.

Based on the foreign object detection results, the analysis unit can propose appropriate evacuation routes to the user. For example, the generative AI proposes appropriate evacuation routes to the user based on the foreign object detection results. For example, it provides audio guidance for safe routes to avoid foreign objects. The analysis unit also analyzes the position and type of foreign objects and proposes specific evacuation routes to the user. For example, it guides the user along evacuation routes suitable for emergencies such as fires or earthquakes. Furthermore, the analysis unit proposes evacuation routes to the user in real time based on the foreign object detection results. For example, if the foreign object is moving, it adjusts the evacuation route according to its movement. This allows visually impaired individuals to know appropriate evacuation routes to avoid foreign objects.

The analysis unit can use an emotion estimation function to adjust the priority of warnings based on the user's feelings toward foreign objects. For example, the generative AI analyzes the user's emotional state and adjusts the priority of warnings based on the user's feelings toward foreign objects. For example, it gives priority to warnings for foreign objects that cause strong anxiety in the user. The analysis unit also uses an emotion estimation function to analyze the user's feelings toward foreign objects and adjust the content of the warning based on those feelings. For example, if the user is relaxed, it issues a concise warning. Furthermore, the analysis unit monitors the user's emotional state in real time and dynamically adjusts the priority of warnings according to changes. For example, if the user's emotions change, it immediately changes the content of the warning. This allows the priority of warnings for foreign objects to be appropriately adjusted according to the user's feelings.

The system according to the embodiment is not limited to the above examples and can be variously modified, for example, as follows.

The analysis unit can analyze weather information from images acquired by the camera and provide appropriate advice to the user. For example, if it starts to rain, it provides audio guidance to carry an umbrella. The analysis unit can also propose appropriate clothing to the user based on weather information. For example, on cold days, it guides the user to wear warm clothes. Furthermore, the analysis unit can propose changes to the travel route based on weather information. For example, if roads become slippery due to heavy rain or snow, it guides the user along an alternative safe route. This makes it easier for visually impaired individuals to respond to changes in weather.

The analysis unit can analyze the user's health condition from images acquired by the camera and provide appropriate advice. For example, it detects signs of fatigue or stress from facial color or expression and provides audio guidance to take a break. The analysis unit can also analyze the user's walking pattern and, if any abnormality is detected, guide the user to see a doctor. For example, if the user's gait becomes unstable, it suggests visiting a medical institution early. Furthermore, the analysis unit can provide daily life advice based on the user's health condition. For example, it proposes appropriate diet or exercise. This makes it easier for visually impaired individuals to maintain their health.

The analysis unit can analyze surrounding sound information from images acquired by the camera and provide appropriate advice to the user. For example, it detects car engine sounds or horn sounds and prompts the user to be careful when crossing the road. The analysis unit can also propose appropriate actions to the user based on surrounding sound information. For example, it guides the user to use earplugs in noisy places. Furthermore, the analysis unit can propose safe travel routes to the user based on surrounding sound information. For example, it guides the user to choose a quiet road for travel. This allows visually impaired individuals to use surrounding sound information to move safely.

The analysis unit can analyze the user's posture from images acquired by the camera and provide appropriate advice. For example, if the user remains in the same posture for a long time, it provides audio guidance to stretch. The analysis unit can also propose appropriate sitting or standing postures based on the user's posture. For example, it guides the user to straighten their back. Furthermore, the analysis unit can provide daily life advice based on the user's posture. For example, it proposes correct working methods for maintaining good posture. This makes it easier for visually impaired individuals to maintain a healthy posture.

The analysis unit can analyze temperature information around the user from images acquired by the camera and provide appropriate advice. For example, if the room temperature is too high, it provides audio guidance to use the air conditioner. The analysis unit can also propose appropriate clothing to the user based on temperature information. For example, it guides the user to wear light clothing on hot days. Furthermore, the analysis unit can propose appropriate actions to the user based on temperature information. For example, if there is a high risk of heatstroke, it provides guidance to stay hydrated. This allows visually impaired individuals to use temperature information to stay comfortable.

The analysis unit can analyze the user's emotional state and propose music according to that emotion. For example, if the user wants to relax, it proposes music with a relaxing effect. The analysis unit can also propose appropriate entertainment based on the user's emotional state. For example, if the user is feeling stressed, it proposes movies or books that help relieve stress. Furthermore, the analysis unit can propose appropriate relaxation methods based on the user's emotional state. For example, it guides the user in meditation or deep breathing techniques. This makes it easier for visually impaired individuals to engage in relaxation according to their emotions.

The analysis unit can analyze the user's emotional state and propose communication methods according to that emotion. For example, if the user is nervous, it proposes conversation topics to help the user relax. The analysis unit can also provide appropriate interpersonal advice based on the user's emotional state. For example, if the user is feeling angry, it proposes methods to calm down. Furthermore, the analysis unit can propose appropriate communication timing based on the user's emotional state. For example, it guides the user to have important conversations when they are relaxed. This makes it easier for visually impaired individuals to communicate according to their emotions.

The analysis unit can analyze the user's emotional state and propose exercise according to that emotion. For example, if the user is feeling stressed, it proposes exercises that help relieve stress. The analysis unit can also propose appropriate exercise intensity based on the user's emotional state. For example, if the user wants to relax, it proposes light exercise. Furthermore, the analysis unit can propose appropriate exercise timing based on the user's emotional state. For example, it guides the user to exercise when they are energetic. This makes it easier for visually impaired individuals to exercise according to their emotions.

The analysis unit can analyze the user's emotional state and propose meals according to that emotion. For example, if the user is tired, it proposes meals to replenish energy. The analysis unit can also propose appropriate meal timing based on the user's emotional state. For example, it guides the user to eat when they are relaxed. Furthermore, the analysis unit can propose appropriate meal content based on the user's emotional state. For example, if the user is feeling stressed, it proposes ingredients that help relieve stress. This makes it easier for visually impaired individuals to have meals according to their emotions.

The analysis unit can analyze the user's emotional state and propose rest according to that emotion. For example, if the user is tired, it proposes appropriate rest methods. The analysis unit can also propose appropriate rest timing based on the user's emotional state. For example, it guides the user to take short breaks when feeling stressed. Furthermore, the analysis unit can propose appropriate rest environments based on the user's emotional state. For example, it guides the user to rest in a quiet place. This makes it easier for visually impaired individuals to take rest according to their emotions.

The following is a brief explanation of the processing flow of Example 2 of the Embodiment.

Step 1: The camera is mounted on glasses and acquires images. For example, the camera may have high resolution, a wide field of view, and a high frame rate.

Step 2: The analysis unit analyzes images acquired by the camera. For example, the analysis unit may use image processing algorithms to analyze the images and extract information with high accuracy.

Step 3: The voice output unit outputs, as audio, information analyzed by the analysis unit. For example, the voice output unit may use speech synthesis technology to generate high-quality audio.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

### Second Embodiment

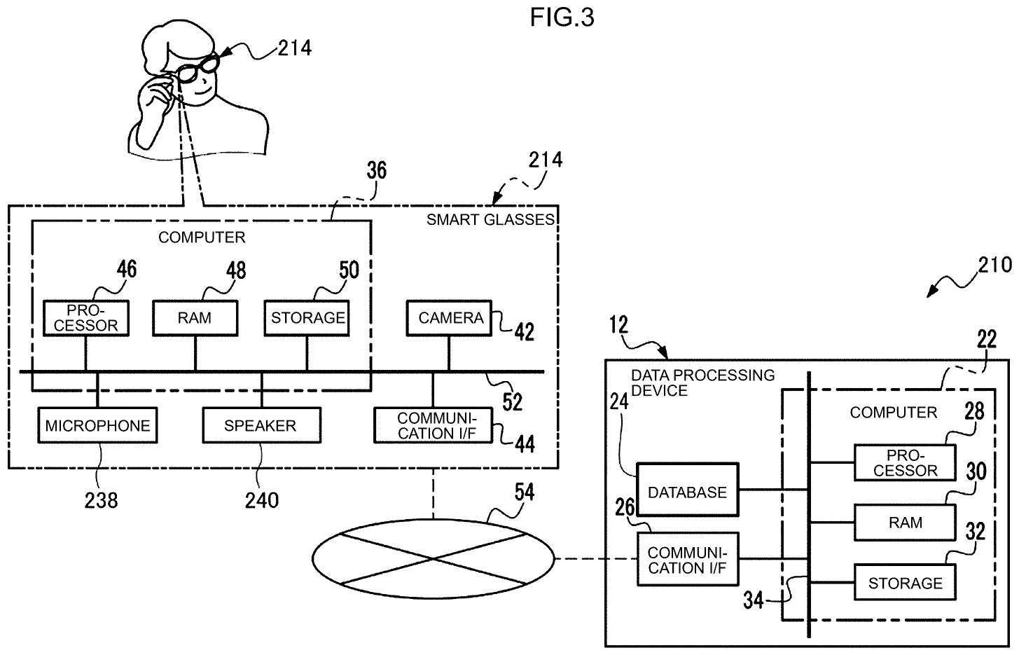

FIG. 3 shows an example of the configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 include a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

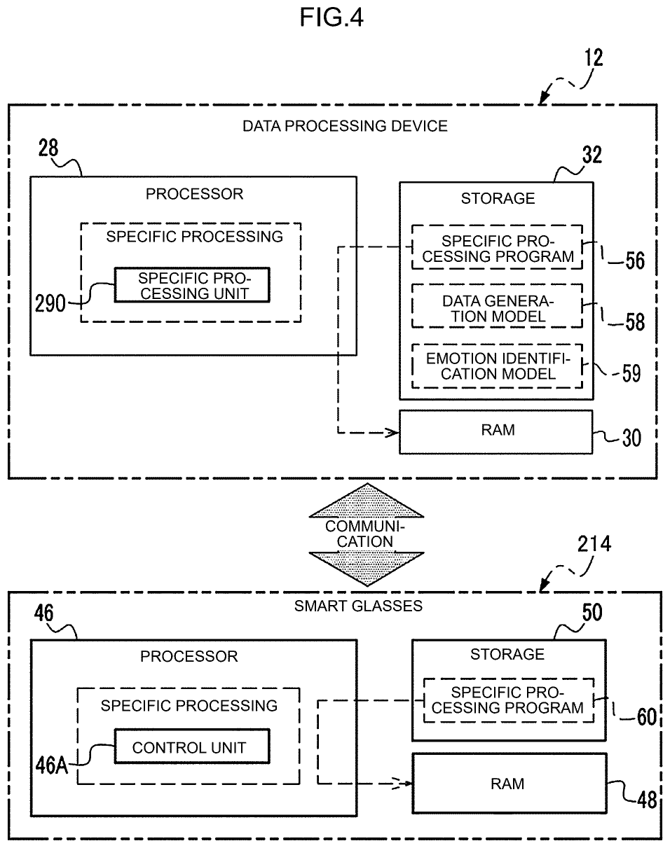

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

### Third Embodiment

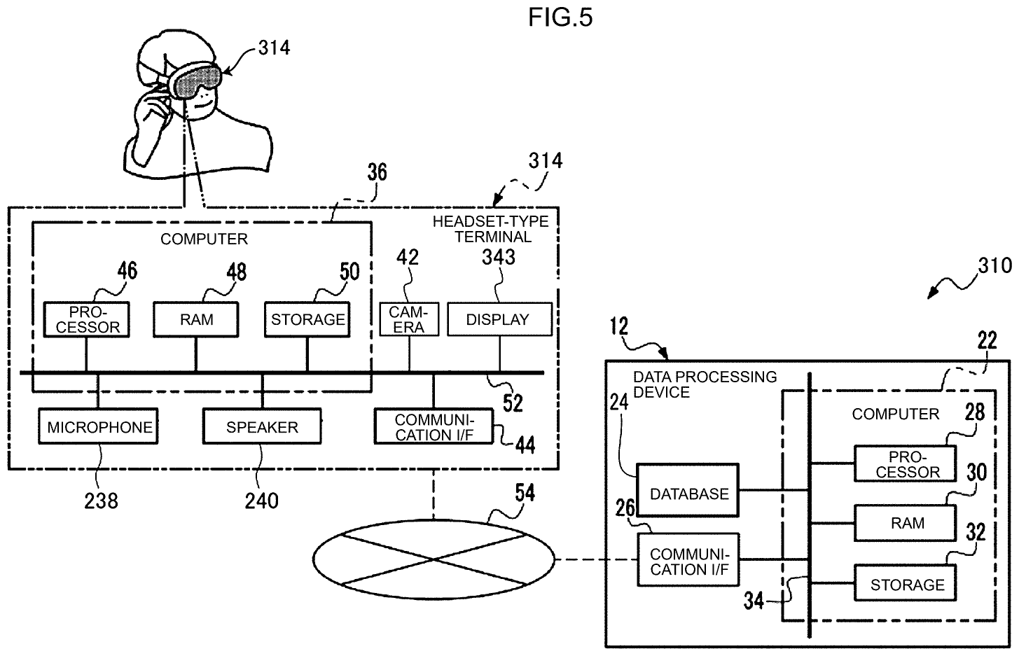

FIG. 5 shows an example of the configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

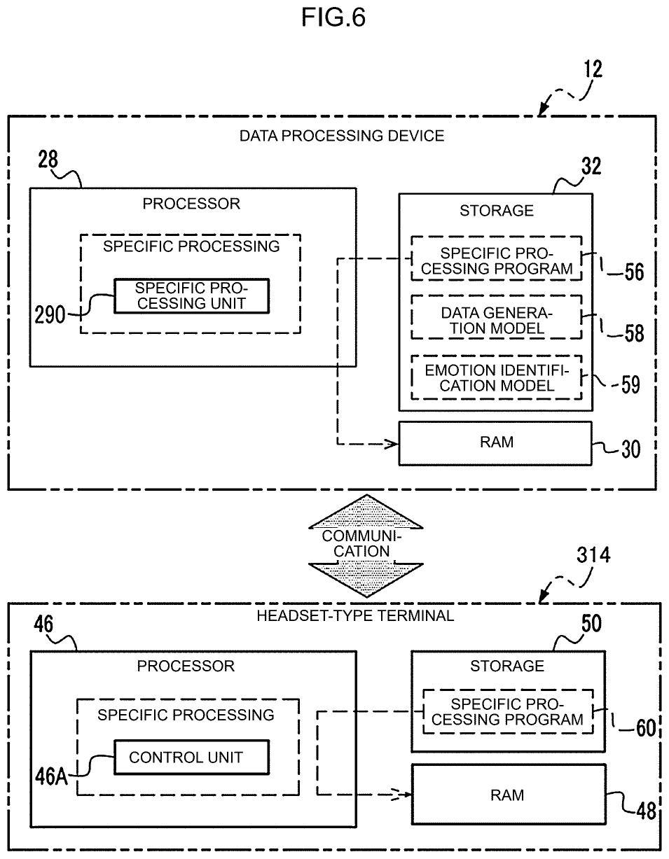

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

### Fourth Embodiment

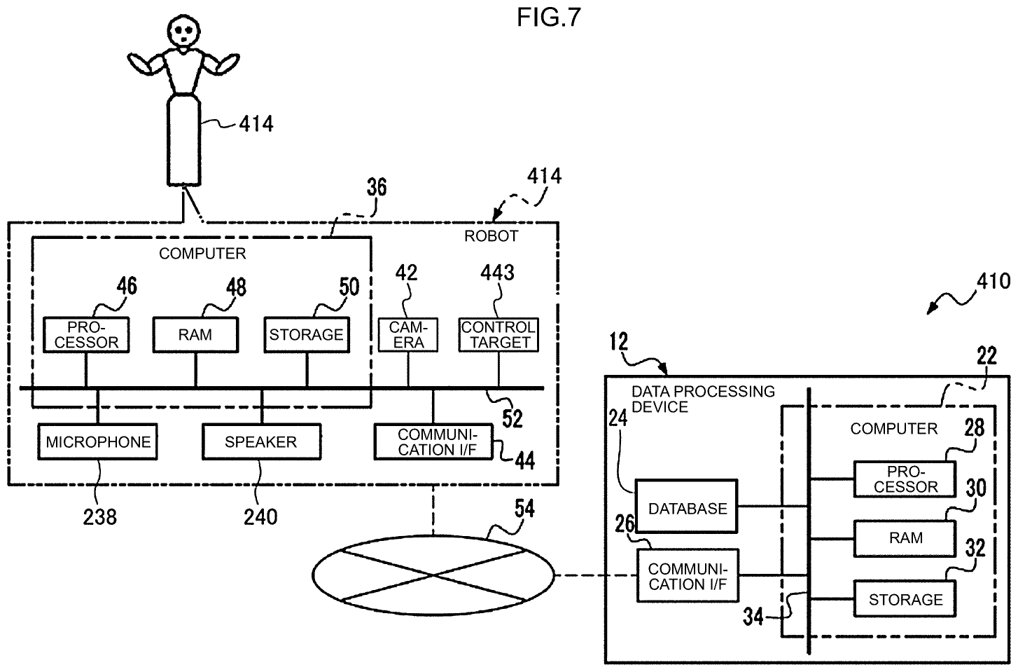

FIG. 7 shows an example of the configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

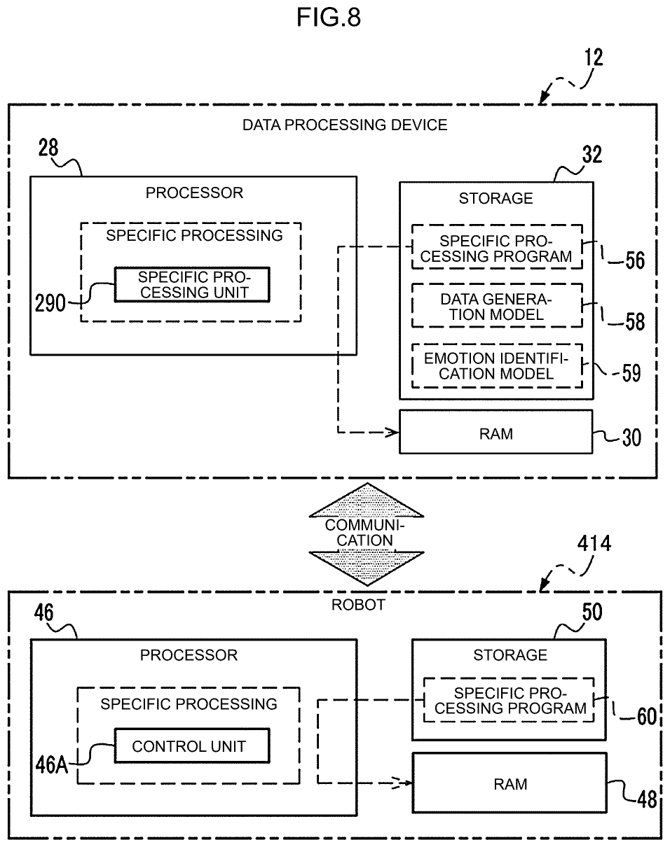

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

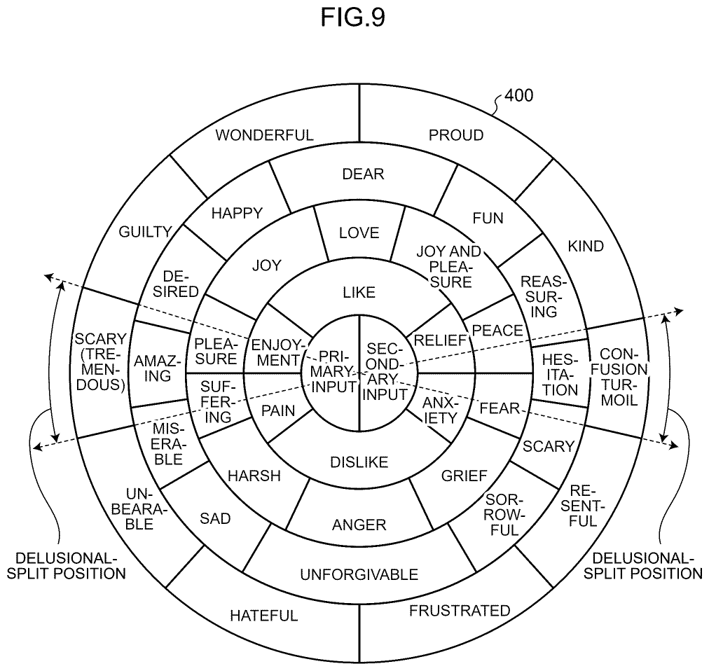

The emotion identification model 59, serving as an emotion engine, may determine the user's emotion according to a specific mapping. Specifically, the emotion identification model 59 may determine the user's emotion according to an emotion map (see FIG. 9), which is a specific mapping. Similarly, the emotion identification model 59 may determine the robot's emotion, and the specific processing unit 290 may perform specific processing using the robot's emotion.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

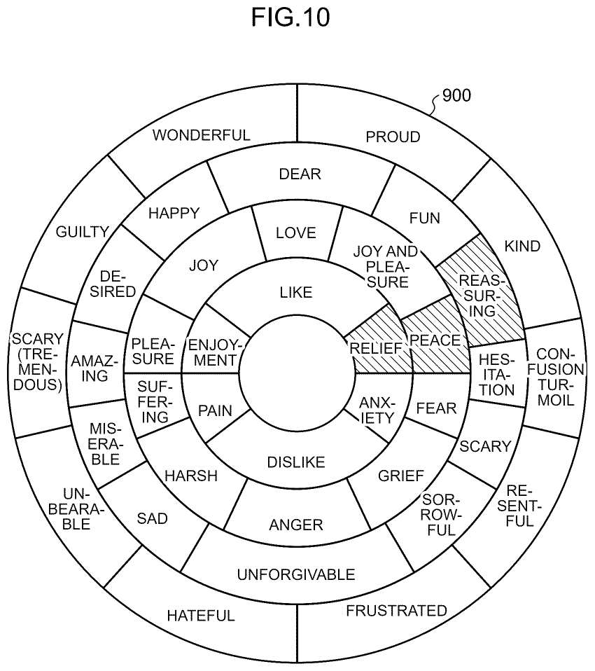

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: two cameras mounted on glasses; an analysis unit that analyzes images acquired by the cameras; and a voice output unit that outputs, as audio, information analyzed by the analysis unit.

2. The system according to claim 1, wherein the analysis unit analyzes character information from images acquired by the cameras and reads the character information aloud as audio.

3. The system according to claim 1, wherein the analysis unit recognizes tactile paving blocks from images acquired by the cameras and provides audio guidance regarding their position and orientation.

4. The system according to claim 1, wherein the analysis unit analyzes images of persons acquired by the cameras and matches them with persons registered in advance as training data.

5. The system according to claim 1, wherein the analysis unit analyzes two images acquired by the cameras and measures the distance to a target object.

6. The system according to claim 1, wherein the analysis unit detects objects or situations other than a specified target object from images acquired by the cameras.
